(19) United States
(12) Patent Application Publication
(10) Pub. No.: US 2025/0148065 A1
(43) Pub. Date: May 8, 2025

(54) INFORMATION PROCESSING APPARATUS, INFORMATION PROCESSING METHOD, AND NON-TRANSITORY RECORDING MEDIUM

(71) Applicant: NEC Corporation, Minato-ku, Tokyo (JP)

(72) Inventor: Toshiyuki SASHIHARA, Tokyo (JP)

(73) Assignee: NEC Corporation, Minato-ku, Tokyo (JP)

(21) Appl. No.: 18/838,668

(22) PCT Filed: Mar. 24, 2022
(86) PCT No.: PCT/JP2022/014022

§ 371 Date: Aug. 15, 2024

(51) Int. Cl. G06F 21/32

(52) U.S. Cl. CPC G06F 21/32

(57) ABSTRACT

An information processing apparatus includes: a first score acquiring unit that acquires a first score indicating a matching score of first biometric recognition using first biometric information about a target; a second score acquiring unit that acquires a second score indicating a matching score of second biometric recognition using second biometric information about the target; a reference data acquiring unit that acquires reference data about at least one of the first biometric recognition and the second biometric recognition; and an integrated score calculation unit that calculates an integrated score on the basis of the first score, the second score, and the reference data. According to the information processing apparatus, it is possible to properly calculate the integrated score.

### TECHNICAL FIELD

This disclosure relates to technical fields of an information processing apparatus, an information processing method, and a recording medium.

### BACKGROUND ART

A known apparatus of this type integrates results of a plurality of types of authentication processing. For example, Patent Literature 1 discloses: integrating a result of face recognition and a result of iris recognition; and outputting an overall authentication result that takes into account the two types of authentication processing. Patent Literature 2 discloses: integrating a matching score calculated by a first verification unit and a matching score calculated by a second verification unit; and outputting an integrated matching score. Patent Literature 3 discloses performing an arithmetic operation using a weighted variable m, on determination results a and b of authentication determinations by authentication methods A and B, thereby performing a final determination.

### CITATION LIST

### Patent Literature

Patent Literature 1: International Publication No. WO2021/090364
Patent Literature 2: International Publication No. WO2013/132695
Patent Literature 3: JP2000-242786A

### SUMMARY

### Technical Problem

This disclosure aims to improve the techniques/technologies disclosed in Citation List.

### Solution to Problem

An information processing apparatus according to an example aspect of this disclosure includes: a first score acquiring unit that acquires a first score indicating a matching score of first biometric recognition using first biometric information about a target; a second score acquiring unit that acquires a second score indicating a matching score of second biometric recognition using second biometric information about the target; a reference data acquiring unit that acquires reference data about at least one of the first biometric recognition and the second biometric recognition; and an integrated score calculation unit that calculates an integrated score on the basis of the first score, the second score, and the reference data.

An information processing method according to an example aspect of this disclosure includes: acquiring a first score indicating a matching score of first biometric recognition using first biometric information about a target; acquiring a second score indicating a matching score of second biometric recognition using second biometric information about the target; acquiring reference data about at least one of the first biometric recognition and the second biometric recognition; and calculating an integrated score on the basis of the first score, the second score, and the reference data.

A recording medium according to an example aspect of this disclosure is a recording medium on which a computer program that allows at least one computer to execute an information processing method is recorded, the information processing method including: acquiring a first score indicating a matching score of first biometric recognition using first biometric information about a target; acquiring a second score indicating a matching score of second biometric recognition using second biometric information about the target; acquiring reference data about at least one of the first biometric recognition and the second biometric recognition; and calculating an integrated score on the basis of the first score, the second score, and the reference data.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a block diagram illustrating a functional configuration of an information processing apparatus according to a second example embodiment.

FIG. 5 is a block diagram illustrating a functional configuration of an information processing apparatus according to a third example embodiment

FIG. 6 is a flowchart illustrating a flow of operation of an information processing apparatus according to a fourth example embodiment.

FIG. 7 is a flowchart illustrating a flow of operation of an information processing apparatus according to a fifth example embodiment.

FIG. 8 is a block diagram illustrating a functional configuration of an information processing apparatus according to a sixth example embodiment.

FIG. 9 is a flowchart illustrating a flow of operation of the information processing apparatus according to the sixth example embodiment.

FIG. 10 is a flowchart illustrating a flow of operation of an information processing apparatus according to a seventh example embodiment.

FIG. 11 is a flowchart illustrating a flow of operation of an information processing apparatus according to an eighth example embodiment.

FIG. 12 is a flowchart illustrating a flow of operation of an information processing apparatus according to a ninth example embodiment.

FIG. 13 is a flowchart illustrating a flow of operation of an information processing apparatus according to a tenth example embodiment.

FIG. 14 is a table illustrating an example of reference data used in an information processing apparatus according to an eleventh example embodiment, and past integrated scores calculated from the reference data.

FIG. 15 is a graph illustrating an example of a personal histogram and another person histogram used in an information processing apparatus according to an eleventh example embodiment.

FIG. 16 is a block diagram illustrating a functional configuration of an information processing apparatus according to a twelfth example embodiment.

FIG. 17 is a flowchart illustrating a flow of operation of the information processing apparatus according to the twelfth example embodiment.

FIG. 18 is a block diagram illustrating a functional configuration of an information processing apparatus according to a thirteenth example embodiment.

FIG. 19 is a flowchart illustrating a flow of operation of an information processing apparatus according to a thirteenth example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

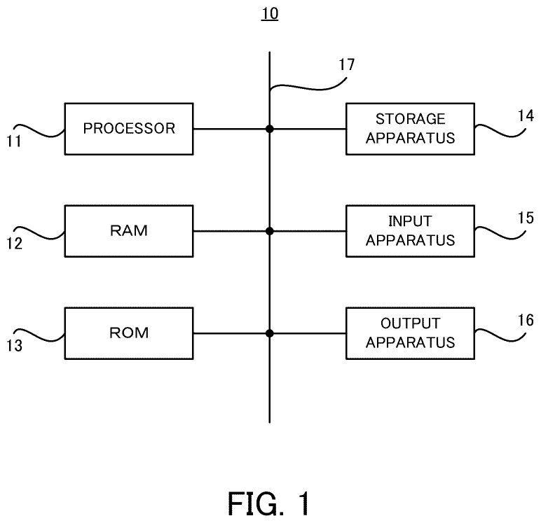

An information processing apparatus according to a first example embodiment will be described with reference to FIG. 1 to FIG. 3.

### (Hardware Configuration)

First, with reference to FIG. 1, a hardware configuration of the information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10, through a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for calculating an integrated score is realized or implemented in the processor 11. As described above, the processor 11 may function as a controller for executing each control in the information processing apparatus 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores data that are stored by the information processing apparatus 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing apparatus 10.

Although FIG. 1 illustrates an example of the information processing apparatus 10 including a plurality of apparatuses, all or a part of the functions may be realized or implemented as a single apparatus. In such a case, the information processing apparatus 10 may include, for example, only the processor 11, the RAM 12, and the ROM 13. The other components (i.e., the storage apparatus 14, the input apparatus 15, and the output apparatus 16) may be provided in an external apparatus connected to the information processing apparatus 10, for example. In addition, in the information processing apparatus 10, a part of an arithmetic function may be realized by an external apparatus (e.g., an external server or cloud, etc.).

### (Functional Configuration)

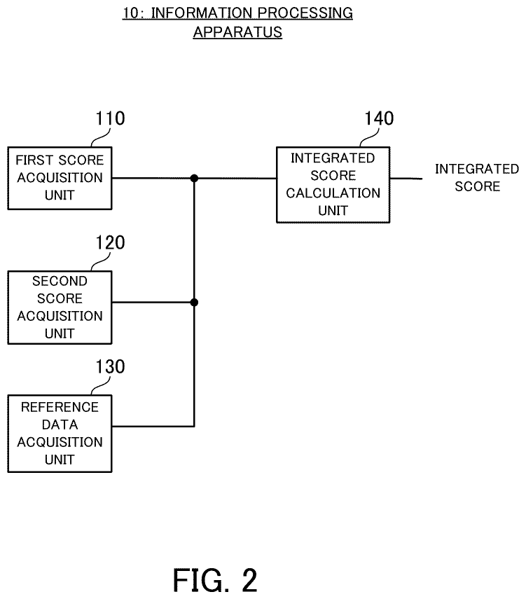

Next, with reference to FIG. 2, a functional configuration of the information processing apparatus 10 according to the first example embodiment will be described. FIG. 2 is a block diagram illustrating the functional configuration of the information processing apparatus according to the first example embodiment.

As illustrated in FIG. 2, the information processing apparatus 10 according to the first example embodiment includes, as components for realizing the functions thereof, a first score acquisition unit 110, a second score acquisition unit 120, a reference data acquisition unit 130, and an integrated score calculation unit 140. Each of the first score acquisition unit 110, the second score acquisition unit 120, the reference data acquisition unit 130, and the integrated score calculation unit 140 may be a processing block realized or implemented by the processor 11 (see FIG. 1), for example.

The first score acquisition unit 110 is constituted to acquire a first score indicating a matching score of first biometric recognition. The first biometric recognition is biometric recognition using first biometric information about a target. The second score acquisition unit 120 is constituted to acquire a second score indicating a matching score of second biometric recognition. The second biometric recognition is biometric recognition using second biometric information (i.e., biometric information that is different from the first biometric information) about the target. An example of the first biometric recognition and the second biometric recognition includes face recognition and iris recognition. In this case, the first biometric information may be acquired as information indicating a face such as a face image, and the second biometric information may be acquired as information indicating an iris such as an iris image. Then, the first score acquisition unit 110 may acquire the first score indicating the matching score of the face recognition using the information indicating the face, and the second score acquisition unit 120 may acquire the second score indicating the matching score of the iris recognition using the information indicating the iris. Note that the face recognition and the iris recognition described above are merely examples, and various types of biometric recognition may be performed by using other types of biometric information. For example, as the first biometric information and the second biometric information, biometric information indicating a fingerprint, a vein, an otoacoustic emission, or the like may be acquired and used to perform fingerprint recognition, vein recognition, otoacoustic recognition, or the like.

The first score acquisition unit 110 and the second score acquisition unit 120 may respectively acquire the first score and the second score as the results of the respective types of biometric recognition performed outside the apparatus. Alternatively, the first score acquisition unit 110 and the second score acquisition unit 120 themselves may respectively perform the respective types of biometric recognition to acquire the first score and the second score. For example, the first score acquisition unit 110 and the second score acquisition unit 120 may respectively acquire the face image and the iris image of the target to perform the respective types of biometric recognition, and may acquire the first score and the second score as the results of the respective types of biometric recognition.

The reference data acquisition unit 130 is configured to acquire reference data. The “reference data” here are data about at least one of the first biometric recognition and the second biometric recognition, and are data used to calculate an integrated score described later. A specific example of the reference data will be described in detail in another example embodiment later.

The integrated score calculation unit 140 is configured to calculate the integrated score on the basis of the first score acquired by the first score acquisition unit 110, the second score acquired by the second score acquisition unit 120, and the reference data acquired by the reference data acquisition unit 130. The “integrated score” here is a score indicating an overall authentication result obtained by integrating the results of both the first biometric recognition and the second biometric recognition. A specific method of calculating the integrated score will be described in detail in another example embodiment later.

### (Flow of Operation)

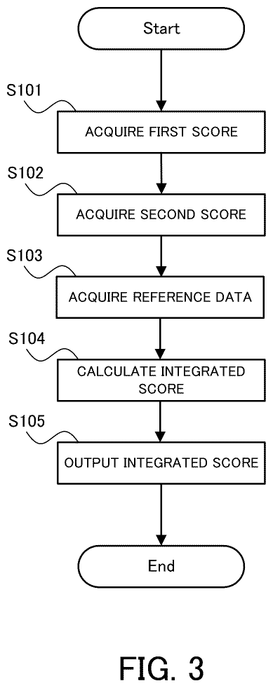

Next, with reference to FIG. 3, a flow of operation of the information processing apparatus 10 according to the first example embodiment (a flow before the integrated score is calculated) will be described. FIG. 3 is a flowchart illustrating the flow of the operation of the information processing apparatus according to the first example embodiment.

As illustrated in FIG. 3, when the operation by the information processing apparatus 10 according to the first example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. The reference data may be acquired before the acquisition of the first score and the second score. Alternatively, the reference data may be acquired simultaneously in parallel with the first score and the second score.

Subsequently, the integrated score calculation unit 140 calculates the integrated score on the basis of the first score acquired by the first score acquisition unit 110, the second score acquired by the second score acquisition unit 120, and the reference data acquired by the reference data acquisition unit 130 (step S104). Then, the integrated score calculation unit 140 outputs the calculated integrated score (step S105).

The outputted integrated score may be used to determine whether the biometric recognition of the target (i.e., biometric recognition as a whole including the first biometric recognition and the second biometric recognition) is successful or failed. For example, when the integrated score is greater than a predetermined score, it may be determined that the biometric recognition of the target is successful. In addition, when the integrated score is less than the predetermined score, it may be determined that the biometric recognition of the target is failed.

### (Technical Effect)

Next, a technical effect obtained by the information processing apparatus 10 according to the first example embodiment will be described.

As described in FIG. 1 to FIG. 3, in the information processing apparatus 10 according to the first example embodiment, the integrated score is calculated on the basis of the first score, the second score, and the reference data. In this way, the reference data about the biometric recognition are considered, and it is thus possible to more properly calculate the integrated score, as compared with a case of calculating the integrated score on the basis of only the first score and the second score.

### Second Example Embodiment

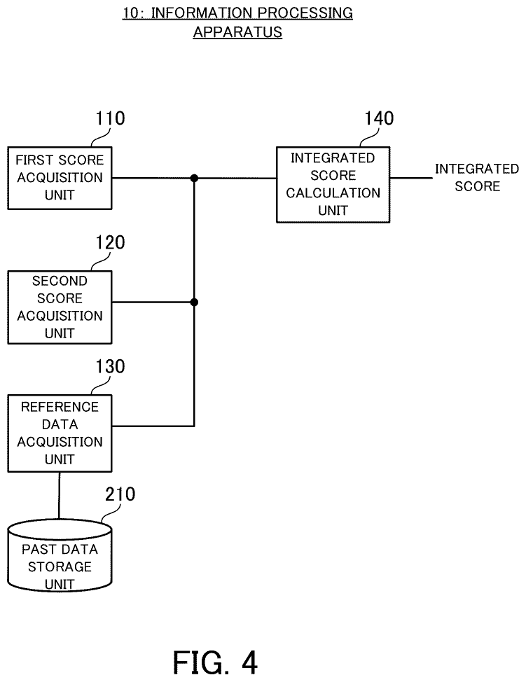

The information processing apparatus 10 according to a second example embodiment will be described with reference to FIG. 4. The second example embodiment is partially different from the first example embodiment only in the configuration and operation, and may be the same as the first example embodiment in the other parts. For this reason, a part that is different from the first example embodiment will be described in detail below, and a description of the other overlapping parts will be omitted as appropriate.

### (Functional Configuration)

First, with reference to FIG. 4, a functional configuration of the information processing apparatus 10 according to the second example embodiment will be described. FIG. 4 is a block diagram illustrating the functional configuration of the information processing apparatus according to the second example embodiment. In FIG. 4, the same components as those illustrated in FIG. 2 carry the same reference numerals.

As illustrated in FIG. 4, the information processing apparatus 10 according to the second example embodiment includes, as components for realizing the functions thereof, the first score acquisition unit 110, the second score acquisition unit 120, the reference data acquisition unit 130, the integrated score calculation unit 140, and a past data storage unit 210. That is, the information processing apparatus 10 according to the second example embodiment further includes the past data storage unit 210 in addition to the configuration in the first example embodiment (see FIG. 2). The past data storage unit 210 may be realized or implemented by the storage apparatus 14 (see FIG. 1), for example.

The past data storage unit 210 is configured to store at least one of the matching scores (i.e., the first score, the second score, and the integrated score) acquired by the first biometric recognition and the second biometric recognition in the past, and the authentication result based on the integrated score. The authentication result may include information including whether or not the authentication result is correct. For example, when the authentication result is wrong, it may include correction information for correcting the result. The correction information may be provided by a human hand, for example.

The past data storage unit 210 may be configured to store matching scores and authentication results acquired by the first biometric recognition and the second biometric recognition of a plurality of people. The past data storage unit 210 may be also configured to store, a plurality of times, the matching score and the authentication result acquired by the first biometric recognition and the second biometric recognition of the same person. The matching score stored in the past data storage unit 210 is readable by the reference data acquisition unit 130 as appropriate. That is, the reference data according to the present example embodiment include the matching score and the authentication result that are acquired by the first biometric recognition and the second biometric recognition in the past and that are stored in the past data storage unit 210. The reference data may include a plurality of matching scores and authentication results.

### (Technical Effect)

Next, a technical effect obtained by the information processing apparatus 10 according to the second example embodiment will be described.

As described in FIG. 4, in the information processing apparatus 10 according to the second example embodiment, at least one of the first score, the second score, and the integrated score acquired in the past is used as the reference data. In this way, the results of the biometric recognition performed in the past are taken into account, and it is thus possible to more properly calculate the integrated score, as compared with a case of using only the present authentication result.

### Third Example Embodiment

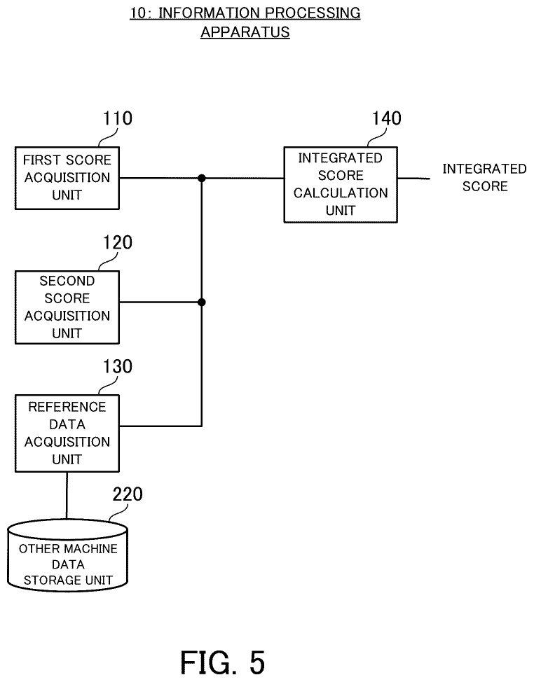

The information processing apparatus 10 according to a third example embodiment will be described with reference to FIG. 5. The third example embodiment is partially different from the first and second example embodiments only in the configuration and operation, and may be the same as the first and second example embodiments in the other parts. For this reason, a part that is different from each of the example embodiments described above will be described in detail below, and a description of the other overlapping parts will be omitted as appropriate.

### (Functional Configuration)

First, with reference to FIG. 5, a functional configuration of the information processing apparatus 10 according to the third example embodiment will be described. FIG. 5 is a block diagram illustrating the functional configuration of the information processing apparatus according to the third example embodiment. In FIG. 5, the same components as those illustrated in FIG. 2 carry the same reference numerals.

As illustrated in FIG. 5, the information processing apparatus 10 according to the third example embodiment includes, as components for realizing the functions thereof, the first score acquisition unit 110, the second score acquisition unit 120, the reference data acquisition unit 130, the integrated score calculation unit 140, and another machine data storage unit 220. That is, the information processing apparatus 10 according to the third example embodiment further includes the other machine data storage unit 220 in addition to the configuration in the first example embodiment (see FIG. 2). The other machine data storage unit 220 may be realized or implemented by the storage apparatus 14 (see FIG. 1), for example.

The other machine data storage unit 220 is configured to store the matching scores and the authentication result acquired by the first biometric recognition and the second biometric recognition performed in a different place (i.e., the matching scores and the authentication result acquired by another machine that is different from the information processing apparatus 10 according to the present example embodiment) from a place of the information processing apparatus 10 (i.e., a place where the information processing apparatus 10 is operated). The “place of the information processing apparatus 10” here is not simply a place where the information processing apparatus 10 is disposed, but may be a place where a part of the information processing apparatus 10 is disposed, or a place where the entire information processing apparatus 10 is disposed. The authentication result may include information including whether or not the authentication result is correct, as described in the second example embodiment. For example, when the authentication result is wrong, it may include correction information for correcting the result. The correction information may be provided by a person operating an apparatus or the like (through an apparatus or the like), for example.

The other machine data storage unit 220 may be configured to store the matching scores acquired in a plurality of places. The matching scores stored in the other machine data storage unit 220 are readable by the reference data acquisition unit 130 as appropriate. That is, the reference data according to the present example embodiment are the matching scores that are acquired by the first biometric recognition and the second biometric recognition performed in different place(s) and that are stored in the other machine data storage unit 220. The reference data may include a plurality of matching scores.

### (Technical Effect)

Next, a technical effect obtained by the information processing apparatus 10 according to the third example embodiment will be described.

As described in FIG. 5, in the information processing apparatus 10 according to the third example embodiment, at least one of the first score, the second score, and the integrated score acquired by another apparatus, is used as the reference data. In this way, the results of the biometric recognition performed in another place are considered, and it is thus possible to more properly calculate the integrated score, as compared with a case of using only the authentication result by a current apparatus.

### Fourth Example Embodiment

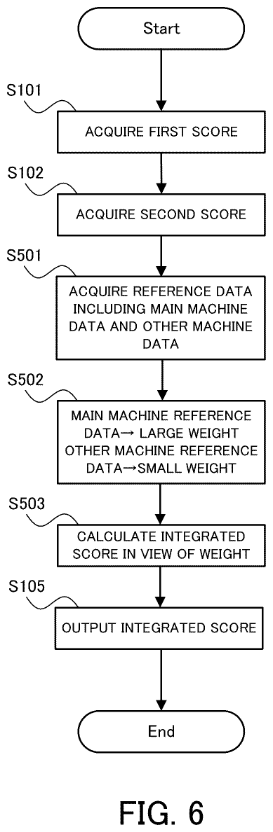

The information processing apparatus 10 according to a fourth example embodiment will be described with reference to FIG. 6. The fourth example embodiment is partially different from the third example embodiment only in the operation, and may be the same as the first to third example embodiments in the other parts. For this reason, a part that is different from each of the example embodiments described above will be described in detail below, and a description of the other overlapping parts will be omitted as appropriate.

### (Flow of Operation)

First, with reference to FIG. 6, a flow of operation of the information processing apparatus 10 according to the fourth example embodiment will be described. FIG. 6 is a flowchart illustrating the flow of the operation of the information processing apparatus according to the fourth example embodiment. In FIG. 6, the same steps as those illustrated in FIG. 3 carry the same reference numerals.

As illustrated in FIG. 6, when the operation by the information processing apparatus 10 according to the fourth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data. The reference data acquisition unit 130 here, in particular, acquires the reference data acquired in a current place (i.e., by the information processing apparatus 10 according to the present example embodiment) (hereinafter referred to as “main machine reference data”) and the reference data acquired in another place (i.e., by another machine) (hereinafter referred to as “other machine reference data”), which are already described in the third example embodiment (step S501). The reference data acquired by the reference data acquisition unit 130 are outputted to the integrated score calculation unit 140.

The integrated score calculation unit 140 then sets a weight about the reference data. Specifically, the integrated score calculation unit 140 sets a weight of the main machine reference data to be larger than a weight of the other machine reference data (step S502). Since the main machine reference data are data acquired in the current place, they are considered to be more suitable as data used to calculate the integrated score, than data acquired in another place (i.e., the other machine reference data). Therefore, here, the weight of the main machine reference data is set to be larger than that of the other machine reference data.

Subsequently, the integrated score calculation unit 140 calculates the integrated score on the basis of the first score acquired by the first score acquisition unit 110, the second score acquired by the second score acquisition unit 120, and the reference data acquired by the reference data acquisition unit 130. In particular, the integrated score calculation unit 140 calculates the integrated score in view of the weight described above (step S503). Therefore, the main machine reference data in which the weight is set large, make a relatively large contribution in calculating the integrated score, and the other machine reference data in which the weight is set small, make a relatively small contribution in calculating the integrated score. Thereafter, the integrated score calculation unit 140 outputs the calculated integrated score (step S105).

### (Technical Effect)

Next, a technical effect obtained by the information processing apparatus 10 according to the fourth example embodiment will be described.

As described in FIG. 6, in the information processing apparatus 10 according to the fourth example embodiment, in a case of using the main machine reference data and the other machine reference data, the weight of the main machine reference data is set to be larger than the weight of the other machine reference data. In this way, an influence of the main machine reference data is relatively increased (in other words, an influence of the other machine reference data is relatively reduced), and it is thus possible to more properly calculate the integrated score.

### Fifth Example Embodiment

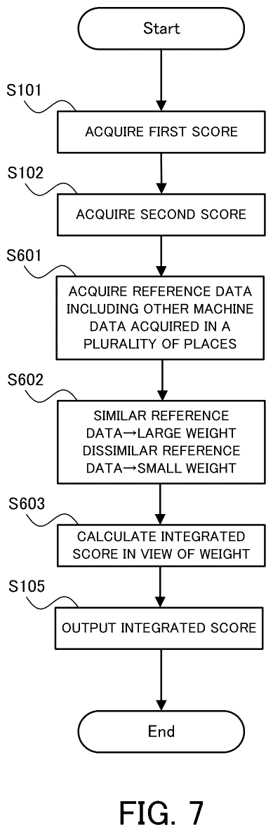

With reference to FIG. 7, the information processing apparatus 10 according to a fifth example embodiment will be described. The fifth example embodiment is partially different from the third and fourth example embodiments only in the operation, and may be the same as the first to fourth example embodiments in the other parts. For this reason, a part that is different from each of the example embodiments described above will be described in detail below, and a description of the other overlapping parts will be omitted as appropriate.

### (Flow of Operation)

First, with reference to FIG. 7, a flow of operation of the information processing apparatus 10 according to the fifth example embodiment will be described. FIG. 7 is a flowchart illustrating the flow of the operation of the information processing apparatus according to the fifth example embodiment. In FIG. 7, the same steps as those illustrated in FIG. 3 carry the same reference numerals.

As illustrated in FIG. 7, when the operation by the information processing apparatus 10 according to the fifth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data. The reference data acquisition unit 130 here, in particular, acquires the other machine reference data acquired in a plurality of places (step S601). The other machine reference data here include similar reference data acquired in another place where a degree of similarity with the current place is higher than a predetermined value, and dissimilar reference data acquired in another place where the degree of similarity with the current place is lower than the predetermined value. The “predetermined value” here is a threshold set in advance to determine whether or not the current place and another place are similar to each other. Furthermore, “similar” means that elements that may affect the result of the biometric recognition are similar. For example, data acquired in a place with similar environmental conditions (e.g., brightness, etc.) for capturing an image used for the biometric recognition, may be classified into the similar reference data, and data acquired in a place with dissimilar environmental conditions, may be classified into the dissimilar reference data. The similar place and the dissimilar place may be classified by a human hand in advance, or may be automatically determined by acquiring various conditions at that time. In the case of automatic determination, for example, it may be determined that the place is similar when the environmental conditions agree by 50% or more, and it may be determined that the place is dissimilar when the environmental conditions do not agree by 50% or more. Alternatively, it may be determined that the place is similar when than a predetermined number or more of items of the environmental condition agree, and it may be determined that the place is dissimilar when a predetermined number or more of items do not agree. The “50%” and the “predetermined number” in the above examples are one specific example of the predetermined value. The reference data acquired by the reference data acquisition unit 130 are outputted to the integrated score calculation unit 140.

The integrated score calculation unit 140 then sets the weight about the reference data. Specifically, the integrated score calculation unit 140 sets a weight of the similar reference data to be larger than a weight of the dissimilar reference data (step S602). Since the similar reference data are data acquired in a place similar to the current place, they are considered to be more suitable as data used to calculate the integrated score, than data acquired in a dissimilar place (i.e., the other machine reference data). Therefore, here, the weight of the similar reference data is set to be larger than the weight of the dissimilar reference data.

Subsequently, the integrated score calculation unit 140 calculates the integrated score on the basis of the first score acquired by the first score acquisition unit 110, the second score acquired by the second score acquisition unit 120, and the reference data acquired by the reference data acquisition unit 130. In particular, the integrated score calculation unit 140 calculates the integrated score in view of the weight described above (step S603). Therefore, the similar reference data in which the weight is set large, make a relatively large contribution in calculating the integrated score, and the dissimilar reference data in which the weight is set small, makes a relatively small contribution in calculating the integrated score. Thereafter, the integrated score calculation unit 140 outputs the calculated integrated score (step S105).

### (Technical Effect)

Next, a technical effect obtained by the information processing apparatus 10 according to the fifth example embodiment will be described.

As described in FIG. 7, in the information processing apparatus 10 according to the fifth example embodiment, in a case of using the similar reference data and the dissimilar reference data, the weight of the similar reference data is set to be larger than the weight of the dissimilar reference data. In this way, an influence of the similar reference data is relatively increased (in other words, an influence of the dissimilar reference data is relatively reduced), and it is thus possible to more properly calculate the integrated score.

### Sixth Example Embodiment

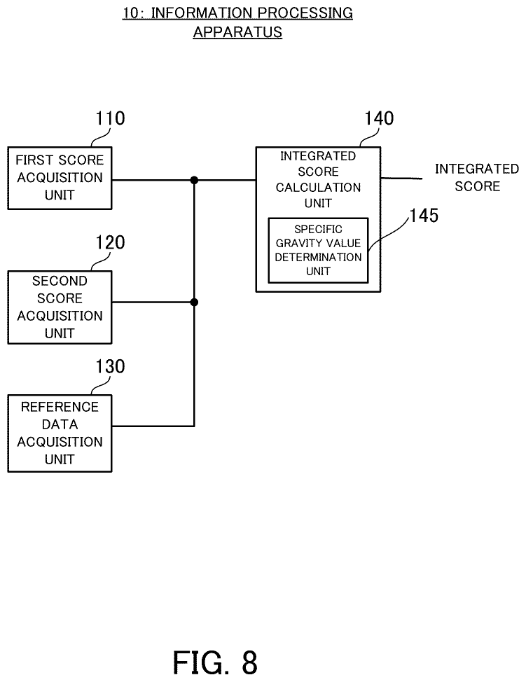

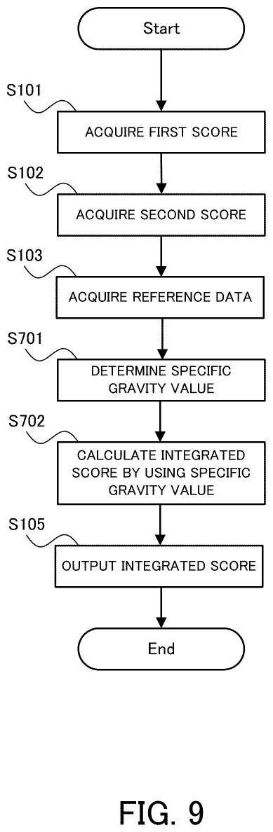

The information processing apparatus 10 according to a sixth example embodiment will be described with reference to FIG. 8 and FIG. 9. The sixth example embodiment is partially different from the first to fifth example embodiments and only in the configuration and operation, and may be the same as the first to fifth example embodiments in the other parts. For this reason, a part that is different from each of the example embodiments described above will be described in detail below, and a description of the other overlapping parts will be omitted as appropriate.

### (Functional Configuration)

First, with reference to FIG. 8, a functional configuration of the information processing apparatus 10 according to the sixth example embodiment will be described. FIG. 8 is a block diagram illustrating the functional configuration of the information processing apparatus according to the sixth example embodiment. In FIG. 8, the same components as those illustrated in FIG. 2 carry the same reference numerals.

As illustrated in FIG. 8, the information processing apparatus 10 according to the second example embodiment includes, as components for realizing the functions thereof, the first score acquisition unit 110, the second score acquisition unit 120, the reference data acquisition unit 130, and the integrated score calculation unit 140. In particular, the integrated score calculation unit 140 according to the sixth example embodiment includes a specific gravity value determination unit 145.

The specific gravity value determination unit 145 is configured to determine a specific gravity value corresponding to at least one or more of the first score and the second score. The specific gravity value determination unit 145 is configured to determine the specific gravity value by using the reference data. A specific method of determining the specific gravity value will be described in detail in another example embodiment later. The specific gravity value is a value indicating to what extent each of the first score and the second score is considered in calculating the integrated score. Therefore, the integrated score calculation unit 140 according to the present example embodiment is configured to calculate the integrated score on the basis of the first score, the second score, and the specific gravity value determined by the specific gravity value determination unit 145.

### (Flow of Operation)

Next, with reference to FIG. 9, a flow of operation of the information processing apparatus 10 according to the sixth example embodiment will be described. FIG. 9 is a flowchart illustrating the flow of the operation of the information processing apparatus according to the sixth example embodiment. In FIG. 9, the same steps as those illustrated in FIG. 3 carry the same reference numerals.

As illustrated in FIG. 9, when the operation by the information processing apparatus 10 according to the sixth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 determines the specific gravity value by using the reference data (step S701). Then, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the sixth example embodiment will be described.

As described in FIG. 8 and FIG. 9, in the information processing apparatus 10 according to the sixth example embodiment, the specific gravity value corresponding to the first score and the second score is determined on the basis of the reference data. In this way, it is possible to easily and properly calculate the integrated score by using the first score, the second score, and the specific gravity value. More specifically, by using the specific gravity value, an influence degree of each of the first score and the second score (i.e., to what extent it is reflected in the integrated score) may be considered, and it is possible to properly calculate the integrated score.

### Seventh Example Embodiment

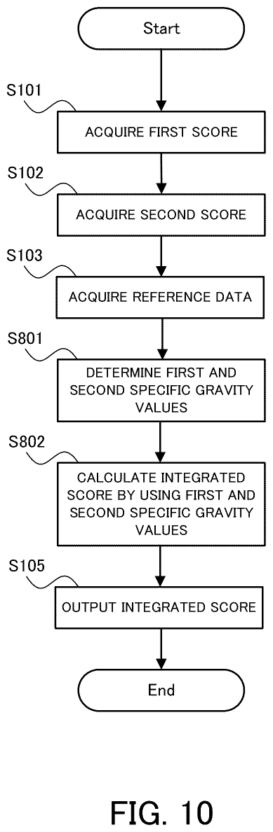

The information processing apparatus 10 according to a seventh example embodiment will be described with reference to FIG. 10. The seventh example embodiment is partially different from the sixth example embodiment only in the operation, and may be the same as the first to sixth example embodiments in the other parts. For this reason, a part that is different from each of the example embodiments described above will be described in detail below, and a description of the other overlapping parts will be omitted as appropriate.

### (Flow of Operation)

First, with reference to FIG. 10, a flow of operation of the information processing apparatus 10 according to the seventh example embodiment will be described. FIG. 10 is a flowchart illustrating the flow of the operation of the information processing apparatus according to the seventh example embodiment. In FIG. 10, the same steps as those illustrated in FIG. 3 carry the same reference numerals.

As illustrated in FIG. 10, when the operation by the information processing apparatus 10 according to the seventh example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 determines a first specific gravity value and a second specific gravity value by using the reference data (step S801). The first specific gravity value is a specific gravity value corresponding to the first score. The second specific gravity value is a specific gravity value corresponding to the second score. That is, in the present example embodiment, two specific gravity values respectively corresponding to the first score and the second score are determined.

Subsequently, the integrated score calculation unit 140 calculates the integrated score on the basis of the first score acquired by the first score acquisition unit 110, the second score acquired by the second score acquisition unit 120, and the first specific gravity value and the second specific gravity value determined by the specific gravity value determination unit 145 (step S802). Specifically, the integrated score calculation unit 140 calculates the integrated score by correcting the first score with the first specific gravity value and by correcting the second score with the second specific gravity value. Thereafter, the integrated score calculation unit 140 outputs the calculated integrated score (step S105).

### (Calculation Example of Integrated Score)

Next, a specific calculation example of calculating the integrated score in the information processing apparatus 10 according to the seventh example embodiment will be described.

For example, in the specific gravity value determination unit 145, it is assumed that a first specific gravity value m and a second specific gravity value n are determined. Note that m and n may or may not be set to satisfy m+n=1. m and n may be set depending on a range of the corresponding first score and second score.

Using the first specific gravity value m and the second specific gravity value n, the integrated score can be calculated as in the following calculation formula (1).

$$Integrated score = m \times first score + n \times second score \qquad ( 1 )$$

The above calculation formula is merely an example, and the integrated score may be calculated by another method.

### (Technical Effect)

Next, a technical effect obtained by the information processing apparatus 10 according to the seventh example embodiment will be described.

As described in FIG. 10, in the information processing apparatus 10 according to the seventh example embodiment, the first specific gravity value corresponding to the first score and the second specific gravity value corresponding to the second score are determined. In this way, it is possible to easily and properly calculate the integrated score by using the first score, the second score, the first specific gravity value, and the second specific gravity value.

### Eighth Example Embodiment

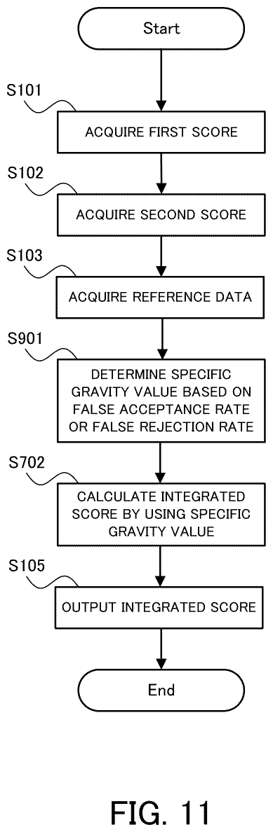

The information processing apparatus 10 according to an eighth example embodiment will be described with reference to FIG. 11. The eighth example embodiment is partially different from the sixth and seventh example embodiments only in the operation, and may be the same as the first to seventh example embodiments in the other parts. For this reason, a part that is different from each of the example embodiments described above will be described in detail below, and a description of the other overlapping parts will be omitted as appropriate.

### (Flow of Operation)

First, with reference to FIG. 11, a flow of operation of the information processing apparatus 10 according to the eighth example embodiment will be described. FIG. 11 is a flowchart illustrating the flow of the operation of the information processing apparatus according to the eighth example embodiment. In FIG. 11, the same steps as those illustrated in FIG. 9 carry the same reference numerals.

As illustrated in FIG. 11, when the operation by the information processing apparatus 10 according to then eighth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 determines the specific gravity value by using the reference data. Specifically, the specific gravity value determination unit 145 determines the specific gravity value such that a false acceptance rate or a false rejection rate satisfies a predetermined condition (step S901). In this case, the false acceptance rate and the false rejection rate are calculated on the basis of the reference data, and may be the false acceptance rate and the false rejection rate in the authentication processing based on past integrated scores, for example. The predetermined condition will be described in detail in another example embodiment later.

Subsequently, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the eighth example embodiment will be described.

As described in FIG. 11, in the information processing apparatus 10 according to the eighth example embodiment, the specific gravity value is determined on the basis of the false acceptance rate and the false rejection rate. In this way, an appropriate specific gravity value can be determined by using the false acceptance rate or the false rejection rate, and it is thus possible to properly calculate the integrated score by using the first score, the second score, and the specific gravity value.

### Ninth Example Embodiment

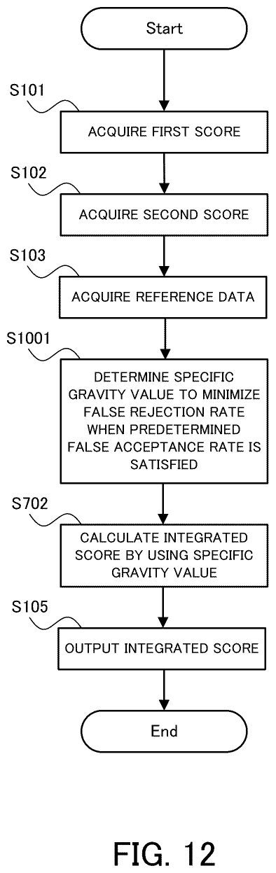

The information processing apparatus 10 according to a ninth example embodiment will be described with reference to FIG. 12. The ninth example embodiment is partially different from the eighth example embodiment only in the operation, and may be the same as the first to eighth example embodiments in the other parts. For this reason, a part that is different from each of the example embodiments described above will be described in detail below, and a description of the other overlapping parts will be omitted as appropriate.

### (Flow of Operation)

First, with reference to FIG. 12, a flow of operation of the information processing apparatus 10 according to the ninth example embodiment will be described. FIG. 12 is a flowchart illustrating the flow of the operation of the information processing apparatus according to the ninth example embodiment. In FIG. 12, the same steps as those illustrated in FIG. 11 carry the same reference numerals.

As illustrated in FIG. 12, when the operation by the information processing apparatus 10 according to the ninth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 calculates the false rejection rate when a predetermined false acceptance rate is satisfied, and determines the specific gravity value so as to minimize the calculated false rejection rate (step S1002). Here, the “predetermined false acceptance rate” may be set as a value low enough not to cause an operational problem. For example, the specific gravity value determination unit 145 may calculate the false rejection rate when the predetermined false acceptance rate is satisfied for all of the plurality of specific gravity values that can be determined, and may determine the specific gravity value when the false rejection rate is the minimum, to be the specific gravity value used to calculate the integrated score. A more specific method of determining the specific gravity value will be described in detail in another example embodiment later.

Subsequently, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the ninth example embodiment will be described.

As described in FIG. 12, in the information processing apparatus 10 according to the ninth example embodiment, the specific gravity value is determined so as to minimize the false rejection rate of a person when the predetermined false acceptance rate is satisfied. In this way, the appropriate specific gravity value can be determined by using the false acceptance rate or the false rejection rate, and it is thus possible to properly calculate the integrated score by using the first score, the second score, and the specific gravity value.

### Tenth Example Embodiment

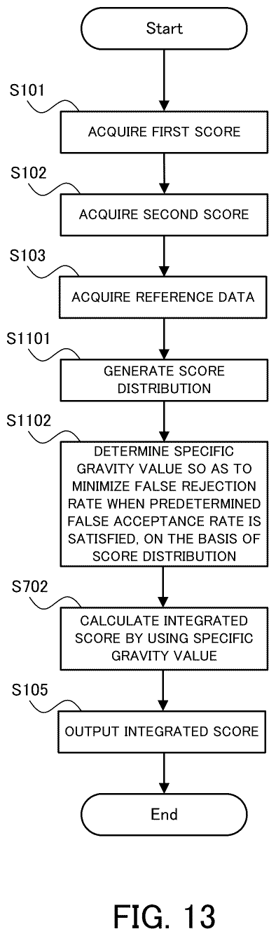

The information processing apparatus 10 according to a tenth example embodiment will be described with reference to FIG. 13. The tenth example embodiment is partially different from the ninth example embodiment only in the operation, and may be the same as the first to ninth example embodiments in the other parts. For this reason, a part that is different from each of the example embodiments described above will be described in detail below, and a description of the other overlapping parts will be omitted as appropriate.

### (Flow of Operation)

First, with reference to FIG. 13, a flow of operation of the information processing apparatus 10 according to the tenth example embodiment will be described. FIG. 13 is a flowchart illustrating the flow of the operation of the information processing apparatus according to the tenth example embodiment. In FIG. 13, the same steps as those illustrated in FIG. 12 carry the same reference numerals.

As illustrated in FIG. 13, when the operation by the information processing apparatus 10 according to the tenth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 generates a score distribution by using the reference data (step S1101). Specifically, the specific gravity value determination unit 145 generates the score distributions of the integrated score for an identical person pair (i.e., the integrated score when an image of the target and a registered image of the target himself are collated/verified) and the integrated score for another person pair (i.e., the integrated score when the image of the target and a registered image of another person are collated/verified).

Subsequently, the specific gravity value determination unit 145 calculates the false rejection rate when the predetermined false acceptance rate is satisfied, by using the generated score distributions, and determines the specific gravity value so as to minimize the calculated false rejection rate (step S1102). A specific method of determining the specific gravity value by using the score distributions will be described in detail in another example embodiment later.

Subsequently, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the tenth example embodiment will be described.

As described in FIG. 13, in the information processing apparatus 10 according to the tenth example embodiment, the distributions of the integrated scores of the identical person pair and the other person pair are generated, and the specific gravity value is determined on the basis of the score distributions. In this way, the appropriate specific gravity value can be determined by using the distributions of the integrated scores, and it is possible to properly calculate the integrated score by using the first score, the second score, and the specific gravity value.

### Eleventh Example Embodiment

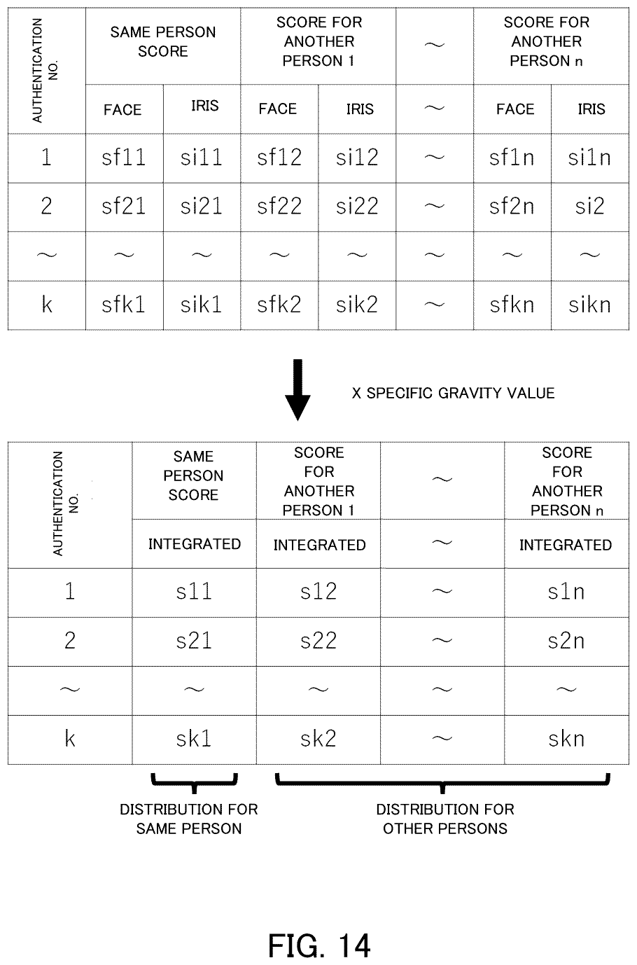

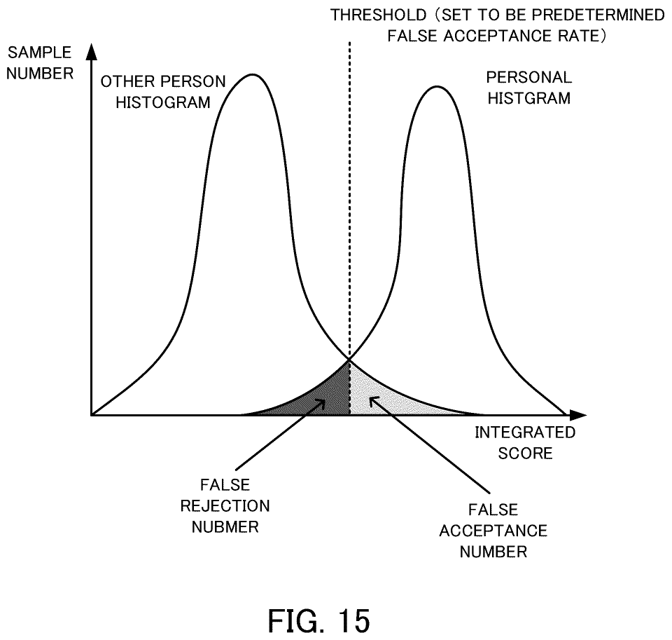

The information processing apparatus 10 according to an eleventh example embodiment will be described with reference to FIG. 14 and FIG. 15. The eleventh example embodiment is partially different from the tenth example embodiment only in the operation, and may be the same as the first to tenth example embodiments in the other parts. For this reason, a part that is different from each of the example embodiments described above will be described in detail below, and a description of the other overlapping parts will be omitted as appropriate.

### (Calculation of Score Distribution)

First, with reference to FIG. 14, a calculation example of calculating the score distribution in the information processing apparatus 10 according to the eleventh example embodiment (i.e., a calculation example of calculating the score distribution used to determine the specific gravity value) will be described. FIG. 14 is a table illustrating an example of the reference data used in the information processing apparatus according to the eleventh example embodiment, and the past integrated scores calculated from the reference data.

As illustrated in FIG. 14, in the information processing apparatus 10 according to the eleventh example embodiment, as the reference data, a personal score (i.e., the first score and the second score for the identical person pair) and another person score (i.e., the first score and the second score for the other person pair) are acquired. For the other person score, n persons of scores that are a score for another person 1 to a score for another person n score is acquired. Each score is acquired k times. Here, as an example of the first score, a score of the face recognition is acquired. As an example of the second score, a score of the iris recognition is acquired.

The specific gravity value determination unit 145 multiplies the personal score and the other person score described above by the specific gravity value (accurately, a candidate of the specific gravity value), thereby calculating the integrated score for the identical person pair and the integrated score for the other person pair. Then, the score distribution of the identical person pair is calculated from the integrated score for the identical person pair, and the score distribution of the other person pair is generated from the integrated score for the other person pair.

### (Determination of Specific Gravity Value)

Next, a method of determining the specific gravity by using the score distribution will be described with reference to FIG. 15. FIG. 15 is a graph illustrating an example of a personal histogram and another person histogram used in the information processing apparatus according to the eleventh example embodiment.

As illustrated in FIG. 15, in the information processing apparatus 10 according to the eleventh example embodiment, the specific gravity value is determined by using the personal histogram illustrating the score distribution of the identical person pair and the other person histogram illustrating the score distribution of the other person pair. Specifically, first, a threshold is set such that the false acceptance rate (i.e., a ratio of a false acceptance number to the whole histogram) obtained from the false acceptance number in the other person histogram (i.e., a part of the other person histogram that is greater than or equal to the threshold) is greater than or equal to a predetermined false acceptance rate. Then, the false rejection rate (i.e., a ratio of a false rejection number to the whole histogram) obtained from the false rejection number in the personal histogram (i.e., a part of the personal histogram that is less than the threshold) is calculated.

The specific gravity value determination unit 145 determines the specific gravity value at which the false rejection rate calculated in the above manner is minimal, to be the specific gravity value used to calculate the integrated score. Specifically, while the specific gravity value is changed, the false rejection rate is calculated for all the candidates of the specific gravity value, and among them, the candidate of the specific gravity value when the false rejection rate is minimal, is determined to be a final specific gravity value.

### (Technical Effect)

Next, a technical effect obtained by the information processing apparatus 10 according to the eleventh example embodiment will be described.

As described in FIG. 14 and FIG. 15, in the information processing apparatus 10 according to the eleventh example embodiment, the specific gravity value is determined by using the personal histogram and the other person histogram. In this way, it is possible to properly determine the specific gravity value so as to minimize the false rejection rate when the predetermined false acceptance rate is satisfied. Therefore, it is possible to properly calculate the integrated score by using the first score, the second score, and the specific gravity value.

### Twelfth Example Embodiment

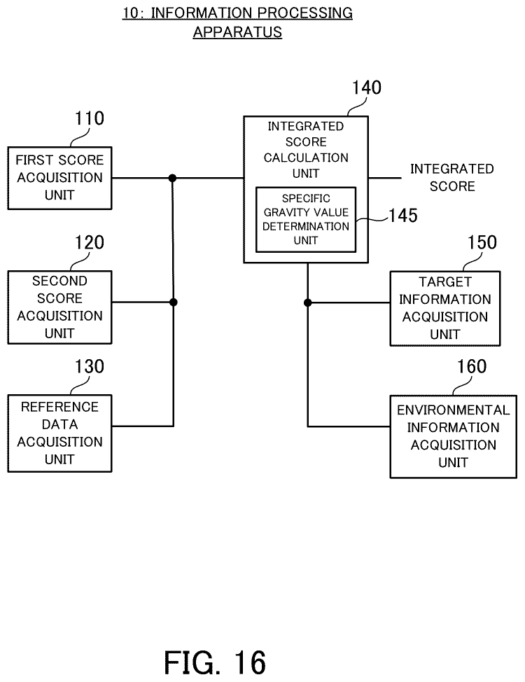

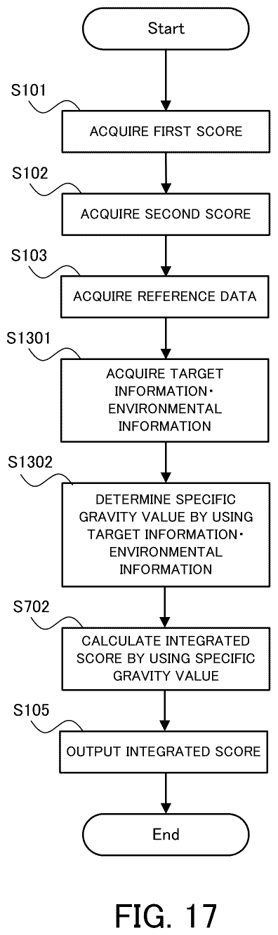

The information processing apparatus 10 according to a twelfth example embodiment will be described with reference to FIG. 16 and FIG. 17. The twelfth example embodiment is partially different from the sixth example embodiment only in the operation, and may be the same as the first to eleventh example embodiments in the other parts. For this reason, a part that is different from each of the example embodiments described above will be described in detail below, and a description of the other overlapping parts will be omitted as appropriate.

### (Functional Configuration)

First, with reference to FIG. 16, a functional configuration of the information processing apparatus 10 according to the twelfth example embodiment will be described. FIG. 16 is a block diagram illustrating the functional configuration of the information processing apparatus according to the twelfth example embodiment. In FIG. 16, the same components as those illustrated in FIG. 8 carry the same reference numerals.

As illustrated in FIG. 16, the information processing apparatus 10 according to the twelfth example embodiment includes, as components for realizing the functions thereof, the first score acquisition unit 110, the second score acquisition unit 120, the reference data acquisition unit 130, the integrated score calculation unit 140, a target information acquisition unit 150, and an environmental information acquisition unit 160. That is, the information processing apparatus 10 according to the twelfth example embodiment further includes the target information acquisition unit 150 and the environmental information acquisition unit 160 in addition to the configuration in the sixth example embodiment (see FIG. 8). Each of the target information acquisition unit 150 and the environmental information acquisition unit 160 may be a processing block realized or implemented by the processor 11 (see FIG. 1), for example.

The target information acquisition unit 150 is configured to acquire information about the target of the first biometric recognition and the second biometric recognition (hereinafter referred to as “target information” as appropriate). Examples of the target information include height, sex, hair type, presence or absence of a wearing item (e.g., presence or absence of glasses or masks), or the like. The target information acquisition unit 150 may acquire the target information from the image of the target, for example. Alternatively, the target information acquisition unit 150 may acquire the target information by using communication with various sensors or user terminals. Alternatively, the target information acquisition unit 150 may acquire the target information from information inputted by the target himself.

The environmental information acquisition unit 160 is configured to acquire information about an environment for performing the first biometric recognition and the second biometric recognition (hereinafter referred to as “environmental information” as appropriate). Examples of the environmental information include a date, a time zone, weather, a lighting condition, a day of the week, number of people around, or the like. The environment information acquisition unit 160 may acquire the environment information by using various sensors, communication, or the like. Alternatively, the environmental information acquisition unit 160 may acquire the environmental information from information inputted by a user of the apparatus or the like.

Note that only one of the target information acquisition unit 150 and the environmental information acquisition unit 160 may be provided. That is, the information processing apparatus according to the twelfth example embodiment may include the target information acquisition unit 150 and may not include the environmental information acquisition unit 160. Alternatively, the information processing apparatus 10 according to the twelfth example embodiment may include the environmental information acquisition unit 160 and may not include the target information acquisition unit 150.

### (Flow of Operation)

Next, with reference to FIG. 17, a flow of operation of the information processing apparatus 10 according to the twelfth example embodiment will be described. FIG. 17 is a flowchart illustrating the flow of the operation of the information processing apparatus according to the twelfth example embodiment. In FIG. 17, the same steps as those illustrated in FIG. 9 carry the same reference numerals.

As illustrated in FIG. 17, when the operation by the information processing apparatus 10 according to the twelfth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the target information acquisition unit 150 and the environmental information acquisition unit 160 respectively acquire the target information and the environmental information (step S1301). Each of the target information and the environmental information is outputted to the specific gravity value determination unit 145 in the integrated score calculation unit 140. The target information and the environmental information may be acquired before the first score, the second score, and the reference data described above. That is, the step S1301 may be performed before and after the steps S101 to S103, or may be performed simultaneously in parallel.

Subsequently, the specific gravity value determination unit 145 determines the specific gravity value by using the target information and the environmental information in addition to the reference data (step S1302). For example, the specific gravity value determination unit 145 may determine an appropriate specific gravity value in accordance with a difference in the target information and a difference in the environmental information. In other words, in different conditions of the target information and the environmental information, the specific gravity value determination unit 145 may determine respective different specific gravity values.

Subsequently, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the twelfth example embodiment will be described.

As described in FIG. 16 and FIG. 17, in the information processing apparatus 10 according to the twelfth example embodiment, the specific gravity value is determined on the basis of at least one of the target information and the environmental information. In this way, the specific gravity value is determined in view of the target and the environment, and it is thus possible to properly calculate the integrated score by using the first score, the second score, and the specific gravity value.

### Thirteenth Example Embodiment

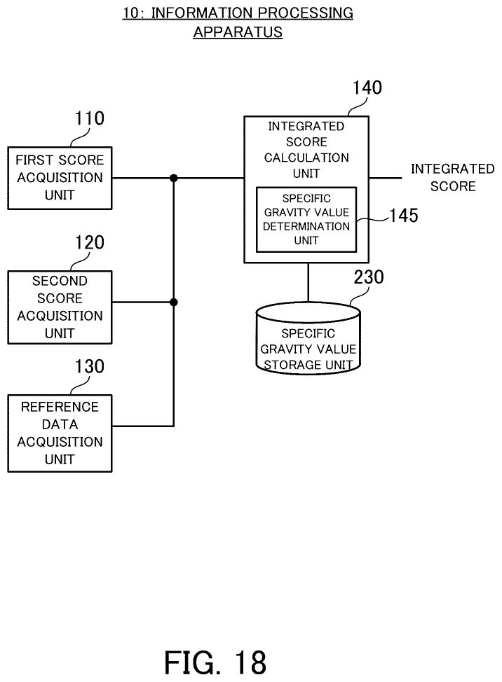

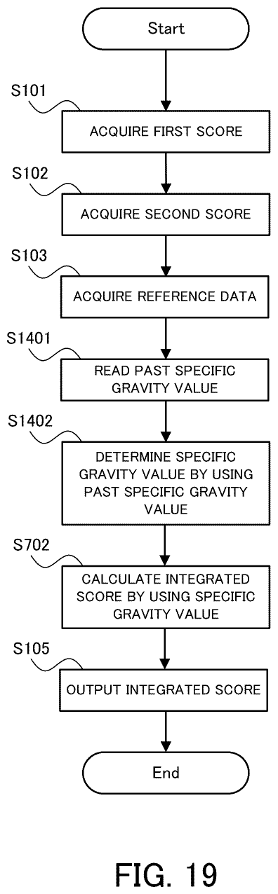

The information processing apparatus 10 according to a thirteenth example embodiment will be described with reference to FIG. 18 and FIG. 19. The thirteenth example embodiment is partially different from the sixth example embodiment only in the operation, and may be the same as the first to twelfth example embodiments in the other parts. For this reason, a part that is different from each of the example embodiments described above will be described in detail below, and a description of the other overlapping parts will be omitted as appropriate.

### (Functional Configuration)

First, with reference to FIG. 18, a functional configuration of the information processing apparatus 10 according to the thirteenth example embodiment will be described. FIG. 18 is a block diagram illustrating the functional configuration of the information processing apparatus according to the thirteenth example embodiment. In FIG. 18, the same components as those illustrated in FIG. 8 carry the same reference numerals.

As illustrated in FIG. 18, the information processing apparatus 10 according to the thirteenth example embodiment includes, as components for realizing the functions thereof, the first score acquisition unit 110, the second score acquisition unit 120, the reference data acquisition unit 130, the integrated score calculation unit 140, and a specific gravity value storage unit 230. That is, the information processing apparatus 10 according to the thirteenth example embodiment further includes the specific gravity value storage unit 230 in addition to the configuration in the sixth example embodiment (see FIG. 8). The specific gravity value storage unit 230 may be realized or implemented by the storage apparatus 14 (see FIG. 1), for example.

The specific gravity value storage unit 230 is configured to store the specific gravity value determined in the past by the specific gravity value determination unit 145. The specific gravity value storage unit 230 may store only one specific gravity value, or may store a plurality of specific gravity values. For example, the specific gravity value storage unit 230 may store only one specific gravity value determined immediately before, or may store a predetermined number of past specific gravity values. The past specific gravity value stored in the specific gravity value storage unit 230 is configured to be read by the specific gravity value determination unit 145 as appropriate. The specific gravity value determination unit 145 according to the present example embodiment is configured to determine a new specific gravity value, by using the past specific gravity value read from the specific gravity value storage unit 230.

### (Flow of Operation)

Next, with reference to FIG. 19, a flow of operation of the information processing apparatus 10 according to the thirteenth example embodiment will be described. FIG. 19 is a flowchart illustrating the flow of the operation of the information processing apparatus according to the thirteenth example embodiment. In FIG. 19, the same steps as those illustrated in FIG. 9 carry the same reference numerals.

As illustrated in FIG. 19, when the operation by the information processing apparatus 10 according to the thirteenth example embodiment is started, first, the first score acquisition unit 110 acquires the first score indicating the matching score of the first biometric recognition (step S101). Furthermore, the second score acquisition unit 120 acquires the second score indicating the matching score of the second biometric recognition (step S102). Each of the first score and the second score is outputted to the integrated score calculation unit 140.

Subsequently, the reference data acquisition unit 130 acquires the reference data (step S103). The reference data acquired by the reference data acquisition unit 130 are outputted to the integrated score calculation unit 140. Especially in the present example embodiment, the reference data are outputted to the specific gravity value determination unit 145 in the integrated score calculation unit 140.

Subsequently, the specific gravity value determination unit 145 reads the past specific gravity value from the specific gravity value storage unit 230 (step S1401). Then, the specific gravity value determination unit 145 determines a new specific gravity value by using the read past specific gravity value, in addition to the reference data (step S1402). For example, the specific gravity value determination unit 145 may calculate the new specific gravity value by using the following calculation formula (2), for example.

$${W}_{k + 1} = n \times {W}_{k} + ( 1 - n ) {W}_{OPT} \qquad ( 2 )$$

wherein Wₖ is the previous specific gravity value (i.e., the past specific gravity value read), W_{OPT} is the specific gravity value calculated by using the reference data, and Wₖ₊₁ is the new specific gravity value determined. By using the above calculation formula, the new specific gravity value may be set a smoothed value. The above calculation formula, however, is merely an example, and the new specific gravity value may be calculated by another method.

Subsequently, the integrated score calculation unit 140 calculates the integrated score on the basis of the first score acquired by the first score acquisition unit 110, the second score acquired by the second score acquisition unit 120, and the specific gravity value determined by the specific gravity value determination unit 145 (step S702). Thereafter, the integrated score calculation unit 140 outputs the calculated integrated score (step S105).

### (Technical Effect)

Next, a technical effect obtained by the information processing apparatus 10 according to the thirteenth example embodiment will be described.

As described in FIG. 18 and FIG. 19, in the information processing apparatus 10 according to the thirteenth example embodiment, the new specific gravity value is determined by using the specific gravity value determined in the past. In this way, a rapid change in the specific gravity value is suppressed, and it is thus possible to properly determine a more appropriate specific gravity value. Therefore, it is possible to properly calculate the integrated score b using the first score, the second score, and the specific gravity value.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes below.

### (Supplementary Note 1)

An information processing apparatus according to Supplementary Note 1 is an information processing apparatus including: a first score acquiring unit that acquires a first score indicating a matching score of first biometric recognition using first biometric information about a target; a second score acquiring unit that acquires a second score indicating a matching score of second biometric recognition using second biometric information about the target; a reference data acquiring unit that acquires reference data about at least one of the first biometric recognition and the second biometric recognition; and an integrated score calculation unit that calculates an integrated score on the basis of the first score, the second score, and the reference data.

### (Supplementary Note 2)

An information processing apparatus according to Supplementary Note 2 is the Information processing apparatus according to Supplementary Note 1, wherein the referenced data include at least one of the first score, the second score, the integrated score that are acquired in a past, and an authentication result based on the integrated score.

### (Supplementary Note 3)

An information processing apparatus according to Supplementary Note 3 is the information processing apparatus according to Supplementary Note 1 or 2, wherein the reference data include at least one of the first score, the second score, and the integrated score that are acquired in a different place from a place where the information processing apparatus is operated, and an authentication result based on the integrated score.

### (Supplementary Note 4)

An information processing apparatus according to Supplementary Note 4 is the information processing apparatus according to Supplementary Note 3, wherein, in a case of using main machine reference data that are the reference data acquired by the information processing apparatus, and other machine reference data that are the reference data acquired in a different place from the place where the information processing apparatus is operated, the integrated score calculation unit sets a weight of the main machine reference data to be larger than a weight of the other machine reference data, thereby calculating the integrated score.

### (Supplementary Note 5)

An information processing apparatus according to Supplementary Note 5 is the information processing apparatus according to Supplementary Note 3 or 4, wherein in a case of using similar reference data that are the reference data acquired in another place where a degree of similarity with the place where the information processing apparatus is operated is higher than a predetermined value, and dissimilar reference data that are the reference data acquired in another place where the degree of similarity with the place where the information processing apparatus is operated is lower than the predetermined value, the integrated score calculation unit sets a weight of the similar reference data to be larger than a weight of the dissimilar reference data, thereby calculating the integrated score.

### (Supplementary Note 6)

An information processing apparatus according to Supplementary Note 6 is the information processing apparatus according to any one of Supplementary Notes 1 to 5, wherein the integrated score calculation unit determines a specific gravity value corresponding to the first score and the second score by using the reference data, and calculates the integrated score on the basis of the first score, the second score, and the specific gravity value.

### (Supplementary Note 7)

An information processing apparatus according to Supplementary Note 7 is the information processing apparatus according to Supplementary Note 6, wherein the integrated score calculation unit determines a first specific gravity value corresponding to the first score and a second specific gravity value corresponding to the second score, by using the reference data, and corrects the first score with the first specific gravity value and corrects the second score with the second specific gravity value, thereby calculating the integrated score.

### (Supplementary Note 8)

An information processing apparatus according to Supplementary Note 8 is the information processing apparatus according to Supplementary Note 6 or 7, wherein the integrated score calculation unit determines the specific gravity value such that a false acceptance rate or a false rejection rate satisfies a predetermined condition, by using the referenced data.

### (Supplementary Note 9)

An information processing apparatus according to Supplementary Note 9 is the information processing apparatus according to Supplementary Note 8, wherein the integrated score calculation unit determines the specific gravity value so as to minimize the false rejection ratio when a predetermined false acceptance ratio is satisfied, by using the referenced data.

### (Supplementary Note 10)

An information processing apparatus according to Supplementary Note 10 is the information processing apparatus according to Supplementary Note 9, wherein the integrated score calculation unit generates distributions of the integrated scores of an identical person pair and another person pair, by using the reference data, and calculates the false rejection rate when the predetermined false acceptance rate is satisfied, on the basis of the distributions of the integrated scores.

### (Supplementary Note 11)

An information processing apparatus according to Supplementary Note 11 is the information processing apparatus according to Supplementary Note 10, wherein the integrated score calculation unit uses a first histogram illustrating the distribution of the integrated score of the other person pair, and sets a threshold score such that a false acceptance rate, which is obtained as a ratio, to a whole, of a part that is greater than or equal to the threshold score in the first histogram, satisfies the predetermined false acceptance rate, and uses a second histogram illustrating the distribution of the integrated score of the identical person pair, and calculates a false rejection rate, which is a ratio, to a whole, of a part that is less than the threshold score in the second histogram.

### (Supplementary Note 12)

An information processing apparatus according to Supplementary Note 12 is the information processing apparatus according to any one of Supplementary Notes 6 to 11, wherein the integrated score calculation unit determines the specific gravity value on the basis of at least one of target information, which is information about the target, and environmental information, which is information about an environment for performing the first biometric recognition and the second biometric recognition, in addition to the reference data.

### (Supplementary Note 13)

An information processing apparatus according to Supplementary Note 13 is the information processing apparatus according to any one of Supplementary Notes 6 to 12, wherein the integrated score calculation unit determines a new specific gravity value by using the specific gravity value determined in a past.

### (Supplementary Note 14)

An information processing method according to Supplementary Note 14 is an information processing method that is executed by at least one computer, the information processing method including: acquiring a first score indicating a matching score of first biometric recognition using first biometric information about a target; acquiring a second score indicating a matching score of second biometric recognition using second biometric information about the target; acquiring reference data about at least one of the first biometric recognition and the second biometric recognition; and calculating an integrated score on the basis of the first score, the second score, and the reference data.

### (Supplementary Note 15)

A recording medium according to Supplementary Note 15 is a recording medium on which a computer program that allows at least one computer to execute an information processing method is recorded, the information processing method including: acquiring a first score indicating a matching score of first biometric recognition using first biometric information about a target; acquiring a second score indicating a matching score of second biometric recognition using second biometric information about the target; acquiring reference data about at least one of the first biometric recognition and the second biometric recognition; and calculating an integrated score on the basis of the first score, the second score, and the reference data.

### (Supplementary Note 16)

A computer program according to Supplementary Note 16 is a computer program that allows at least one computer to execute an information processing method, the information processing method including: acquiring a first score indicating a matching score of first biometric recognition using first biometric information about a target; acquiring a second score indicating a matching score of second biometric recognition using second biometric information about the target; acquiring reference data about at least one of the first biometric recognition and the second biometric recognition; and calculating an integrated score on the basis of the first score, the second score, and the reference data.

### (Supplementary Note 17)

An information processing system according to Supplementary Note 17 is an information processing system including: a first score acquiring unit that acquires a first score indicating a matching score of first biometric recognition using first biometric information about a target; a second score acquiring unit that acquires a second score indicating a matching score of second biometric recognition using second biometric information about the target; a reference data acquiring unit that acquires reference data about at least one of the first biometric recognition and the second biometric recognition; and an integrated score calculation unit that calculates an integrated score on the basis of the first score, the second score, and the reference data.

This disclosure is allowed to be changed, if desired, without departing from the essence or spirit of this disclosure which can be read from the claims and the entire specification. An information processing apparatus, an information processing method, and a recording medium with such changes are also intended to be within the technical scope of this disclosure.

### Description of Reference Codes

10 Information processing apparatus
11 Processor
14 Storage apparatus
110 First score acquisition unit
120 Second score acquisition unit
130 Reference data acquisition unit
140 Integrated score calculation unit
145 Specific gravity value determination unit
150 Target information acquisition unit
160 Environmental information acquisition unit
210 Past data storage unit
220 Other machine data storage unit
230 Specific gravity value storage unit

What is claimed is:

1. An information processing apparatus comprising:
at least one memory that is configured to store instructions; and
at least one processor that is configured to execute the instructions to:
acquire a first score indicating a matching score of first biometric recognition using first biometric information about a target;
acquire a second score indicating a matching score of second biometric recognition using second biometric information about the target;
acquire reference data about at least one of the first biometric recognition and the second biometric recognition; and
calculate an integrated score on the basis of the first score, the second score, and the reference data.

2. The Information processing apparatus according to claim 1, wherein the referenced data include at least one of the first score, the second score, the integrated score that are acquired in a past, and an authentication result based on the integrated score.

3. The information processing apparatus according to claim 1, wherein the reference data include at least one of the first score, the second score, and the integrated score that are acquired in a different place from a place where the information processing apparatus is operated, and an authentication result based on the integrated score.

4. The information processing apparatus according to claim 3, wherein, in a case of using main machine reference data that are the reference data acquired by the information processing apparatus, and other machine reference data that are the reference data acquired in a different place from the place where the information processing apparatus is operated, the at least one processor is configured to execute the instructions to set a weight of the main machine reference data to be larger than a weight of the other machine reference data, thereby calculating the integrated score.

5. The information processing apparatus according to claim 3, wherein in a case of using similar reference data that are the reference data acquired in another place where a degree of similarity with the place where the information processing apparatus is operated is higher than a predetermined value, and dissimilar reference data that are the reference data acquired in another place where the degree of similarity with the place where the information processing apparatus is operated is lower than the predetermined value, the at least one processor is configured to execute the instructions to set a weight of the similar reference data to be larger than a weight of the dissimilar reference data, thereby calculating the integrated score.

6. The information processing apparatus according to claim 1, wherein the at least one processor is configured to execute the instructions to:
determine a specific gravity value corresponding to the first score and the second score by using the reference data; and
calculate the integrated score on the basis of the first score, the second score, and the specific gravity value.

7. The information processing apparatus according to claim 6, wherein the at least one processor is configured to execute the instructions to:
determine a first specific gravity value corresponding to the first score and a second specific gravity value corresponding to the second score, by using the reference data; and
correct the first score with the first specific gravity value and correct the second score with the second specific gravity value, thereby calculating the integrated score.

8. The information processing apparatus according to claim 6, wherein the at least one processor is configured to execute the instructions to determine the specific gravity value such that a false acceptance rate or a false rejection rate satisfies a predetermined condition, by using the referenced data.

9. The information processing apparatus according to claim 8, wherein the at least one processor is configured to execute the instructions to determine the specific gravity value so as to minimize the false rejection ratio when a predetermined false acceptance ratio is satisfied, by using the referenced data.

10. The information processing apparatus according to claim 9, wherein the at least one processor is configured to execute the instructions to:
generate distributions of the integrated scores of an identical person pair and another person pair, by using the reference data; and
calculate the false rejection rate when the predetermined false acceptance rate is satisfied, on the basis of the distributions of the integrated scores.

11. The information processing apparatus according to claim 10, wherein the at least one processor is configured to execute the instructions to:
use a first histogram illustrating the distribution of the integrated score of the other person pair, and set a threshold score such that a false acceptance rate, which is obtained as a ratio, to a whole, of a part that is greater than or equal to the threshold score in the first histogram, satisfies the predetermined false acceptance rate; and
use a second histogram illustrating the distribution of the integrated score of the identical person pair, and calculate a false rejection rate, which is a ratio, to a whole, of a part that is less than the threshold score in the second histogram.

12. The information processing apparatus according to claim 6, wherein the at least one processor is configured to execute the instructions to determine the specific gravity value on the basis of at least one of target information, which is information about the target, and environmental information, which is information about an environment for performing the first biometric recognition and the second biometric recognition, in addition to the reference data.

13. The information processing apparatus according to claim 6, wherein the at least one processor is configured to execute the instructions to determine a new specific gravity value by using the specific gravity value determined in a past.

14. An information processing method that is executed by at least one computer, the information processing method comprising:
acquiring a first score indicating a matching score of first biometric recognition using first biometric information about a target;
acquiring a second score indicating a matching score of second biometric recognition using second biometric information about the target;
acquiring reference data about at least one of the first biometric recognition and the second biometric recognition; and
calculating an integrated score on the basis of the first score, the second score, and the reference data.

15. A non-transitory recording medium on which a computer program that allows at least one computer to execute an information processing method is recorded, the information processing method including:
acquiring a first score indicating a matching score of first biometric recognition using first biometric information about a target;
acquiring a second score indicating a matching score of second biometric recognition using second biometric information about the target;
acquiring reference data about at least one of the first biometric recognition and the second biometric recognition; and
calculating an integrated score on the basis of the first score, the second score, and the reference data.
